(19) United States
(12) Patent Application Publication
(10) Pub. No.: US 2026/0178174 A1
(43) Pub. Date: Jun. 25, 2026

(54) METHOD AND APPARATUS FOR GENERATING AND PLAYING BACK SOUND

(71) Applicant: SAMSUNG ELECTRONICS CO., LTD., Suwon-si (KR)

(72) Inventors: Dongil SON, Suwon-si, (KR); Dasom KIM, Suwon-si (KR); Yejin KIM, Suwon-si (KR); Hyunjin SHIN, Suwon-si (KR)

(21) Appl. No.: 19/541,907

(22) Filed: Feb. 17, 2026

Related U.S. Application Data
(63) Continuation of application No. PCT/KR2024/010940, filed on Jul. 26, 2024.

(30) Foreign Application Priority Data
Oct. 11, 2023 (KR) 10-2023-0134901
Nov. 23, 2023 (KR) 10-2023-0164557

(51) Int. Cl. G06F 3/04842

(52) U.S. Cl. CPC G06F 3/04842

(57) ABSTRACT

An electronic device may include: a speaker; a display; a processor; and a memory storing instructions, wherein the instructions, when executed by the processor, may cause the electronic device to: display at least a part of a page through the display based on entering the page including a plurality of pieces of content; determine whether to generate sound based on information about the page; and obtain the sound using information about at least some of the plurality of pieces of content based on determining to generate the sound.

### CROSS-REFERENCE TO RELATED APPLICATIONS

This application is a continuation of International Application No. PCT/KR2024/010940 designating the United States, filed on Jul. 26, 2024, in the Korean Intellectual Property Receiving Office and claiming priority to Korean Patent Application Nos. 10-2023-0134901, filed on Oct. 11, 2023, and 10-2023-0164557, filed on Nov. 23, 2023, in the Korean Intellectual Property Office, the disclosures of each of which are incorporated by reference herein in their entireties.

### BACKGROUND

### Field

The disclosure relates to a method of obtaining and playing sound.

### Description of Related Art

In a conventional sound source providing service, a service provider determines a sound source suitable for specific content, and when the content is played, the service provider generates and provides the sound source to a user or selects and plays a sound source suitable for a situation of the user using a sound source library in a storage unit of an electronic device of the user or a storage device of a server.

### SUMMARY

According to an example embodiment, an electronic device includes: a speaker, a display, at least one processor, comprising processing circuitry, and a memory storing instructions, wherein at least one processor, individually and/or collectively, is configured to execute the instructions and to cause the electronic device to: based on entering a page including a plurality of contents, display at least a portion of the page on the display, based on information about the page; determine whether to generate a sound; and based on determining to generate the sound, obtain the sound using information about at least some of the plurality of contents.

According to an example embodiment, a method performed by an electronic device includes: based on entering a page including a plurality of contents, displaying at least a portion of the page on the display, based on information about the page; determining whether to generate a sound; and based on determining to generate the sound, obtaining the sound using information about at least some of the plurality of contents.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments.

FIG. 2A is a flowchart illustrating example method of generating and playing sound by an electronic device according to various embodiments.

FIG. 2B is a diagram illustrating an example of a page according to various embodiments.

FIG. 2C is a diagram illustrating an example operation of an electronic device to obtain sound generated using a sound generation model according to various embodiments.

FIG. 2D is a diagram illustrating an example operation of an electronic device to generate a prompt using a content parsing module and a prompt generation model according to various embodiments.

FIG. 3 is a diagram illustrating an example of a page, a plurality of contents, and a display area according to various embodiments.

FIG. 4A is a flowchart illustrating an example operation of an electronic device to obtain sound based on stay time according to various embodiments.

FIG. 4B is a diagram illustrating an example operation of an electronic device to determine a stay time according to various embodiments.

FIG. 5A is a diagram illustrating an example operation of an electronic device to determine information regarding staying in a chat page according to various embodiments.

FIG. 5B is a diagram illustrating an example operation of an electronic device to generate a prompt for a chat page according to various embodiments.

FIG. 5C is a flowchart illustrating an example operation of an electronic device to determine whether to keep playing sound when leaving from a page according to various embodiments.

FIG. 5D is a diagram illustrating an example operation of an electronic device to play sound when re-entering a page within a threshold time according to various embodiments.

FIG. 6A is a diagram illustrating an example operation of an electronic device to generate different sounds when moving from a page to another page according to various embodiments.

FIG. 6B is a flowchart illustrating an example operation of an electronic device to determine whether to keep playing sound based on a similarity between a page and another page when moving from the page to the other page according to various embodiments.

FIG. 6C is a diagram illustrating an example operation of an electronic device to determine a similarity between pages using a previous page comparison module of a stay determination module according to various embodiments.

FIG. 7 is a flowchart illustrating an example operation of an electronic device to obtain a plurality of sounds according to various embodiments.

FIG. 8 is a diagram illustrating an example operation of an electronic device to play sound when entering a page containing a plurality of contents classified into a plurality of topics according to various embodiments.

FIG. 9 is a block diagram illustrating an example configuration of an electronic device according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements and a repeated description related thereto may not be provided.

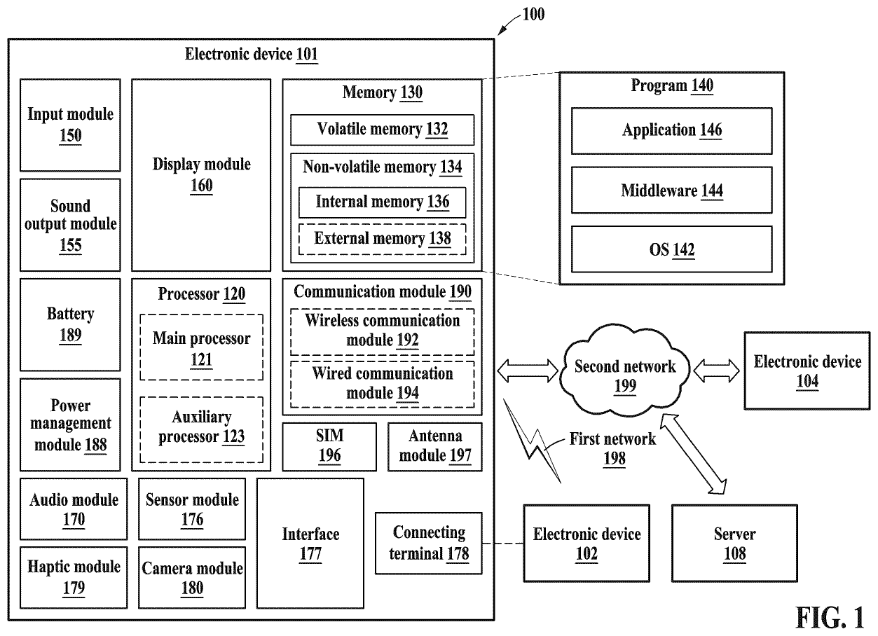

FIG. 1 is a block diagram illustrating an example electronic device in a network environment according to various embodiments.

Referring to FIG. 1, an electronic device 101 in the network environment 100 may communicate with an electronic device 102 via a first network 198 (e.g., a short-range wireless communication network), or communicate with an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added to the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to sense a touch, or a pressure sensor adapted to measure an intensity of a force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed by the electronic device 101 may be executed by the external electronic devices 102 and 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

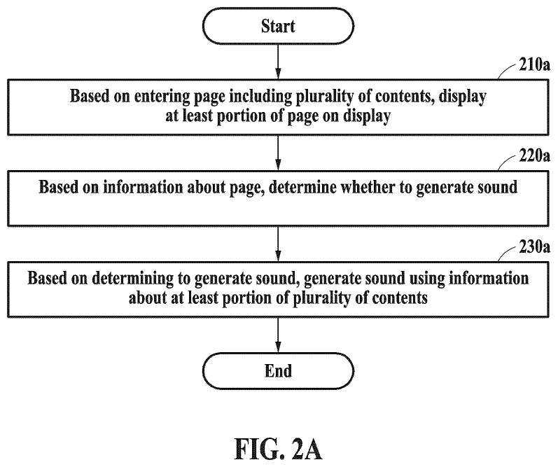

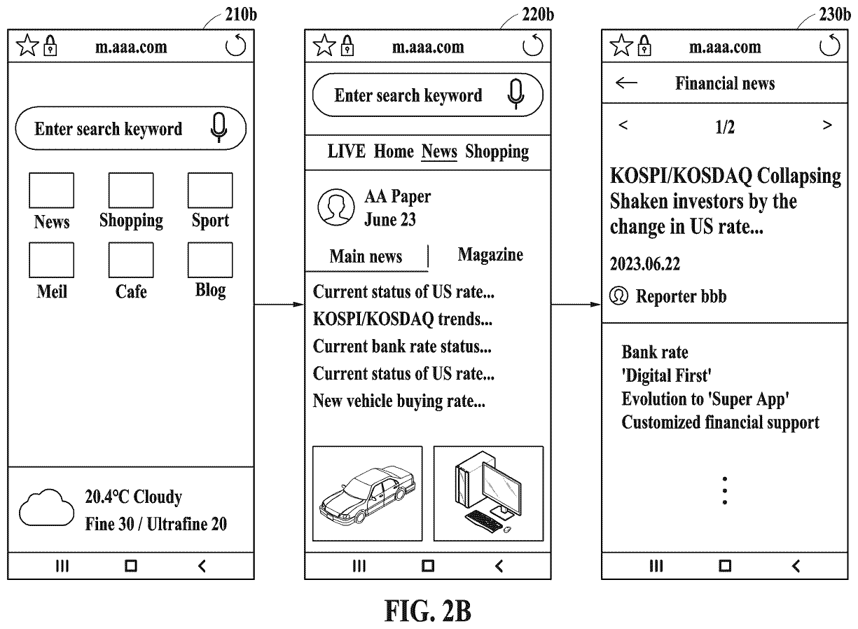

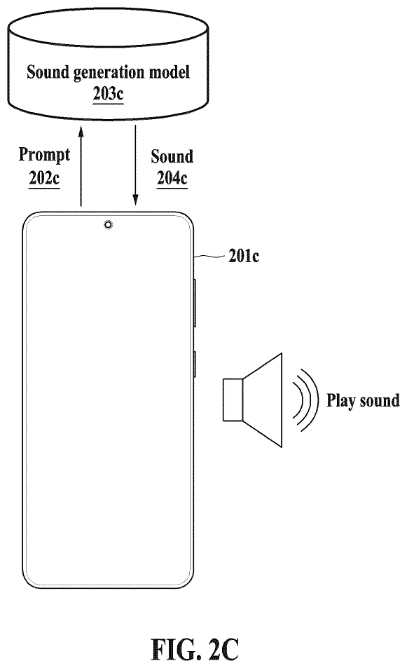

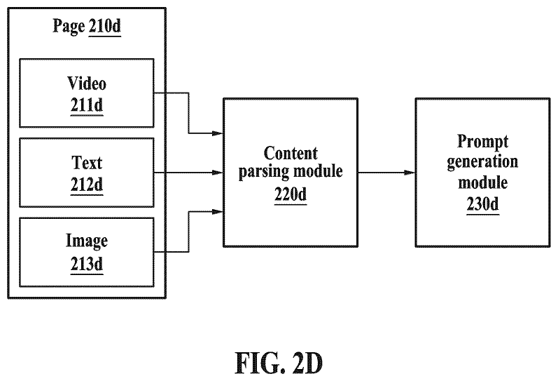

FIG. 2A is a flowchart illustrating an example method of generating and playing sound by an electronic device according to various embodiments. FIG. 2B is a diagram illustrating an example of a page according to various embodiments. FIG. 2C is a diagram illustrating an example operation of an electronic device to obtain sound generated using a sound generation model according to various embodiments. FIG. 2D is a diagram illustrating an example operation of an electronic device to generate a prompt using a content parsing module and a prompt generation model according to various embodiments.

An electronic device according to an embodiment (e.g., the electronic device 101 of FIG. 1) may obtain (e.g., generate) and play a sound based on a page displayed on a display (e.g., the display module 160 of FIG. 1).

In operation 210a, based on entering a page, the electronic device may display at least a portion of the page on the display.

According to an embodiment, the page may include a web page. The web page may be a wired and/or wireless Internet page and may be provided via an Internet protocol-based network (e.g., the network 199 or the server 108 of FIG. 1). The web page may have a uniform resource locator (URL) address to define an access path. For example, the web page may be implemented in the form of a hypertext markup language (HTML) document or an extensible markup language (XML) document. The web page may be a part of a website, which is a collection of interconnected web pages. For example, based on obtaining an entry input that specifies a web page, the electronic device may enter the web page.

According to an embodiment, the page may correspond to an area provided by an application (e.g., the application 146 of FIG. 1). The area may include a two-dimensional (2D) area (e.g., a planar area) or a three-dimensional (3D) area (e.g., a solid area). For example, while executing the application, based on obtaining an entry input to a page corresponding to the area provided by the application, the electronic device may enter the page corresponding to the area.

According to an embodiment, the page may correspond to a space (e.g., a virtual space) provided by the application (e.g., the application 146 of FIG. 1). For example, the page may include a page corresponding to a chat room provided by a messaging application. In the present disclosure, the page corresponding to the chat room may also be referred to as a “chat room page”. For example, while executing the application, based on obtaining an entry input to a page (e.g., the chat room page) corresponding to the space provided by the application, the electronic device may enter the page corresponding to the space.

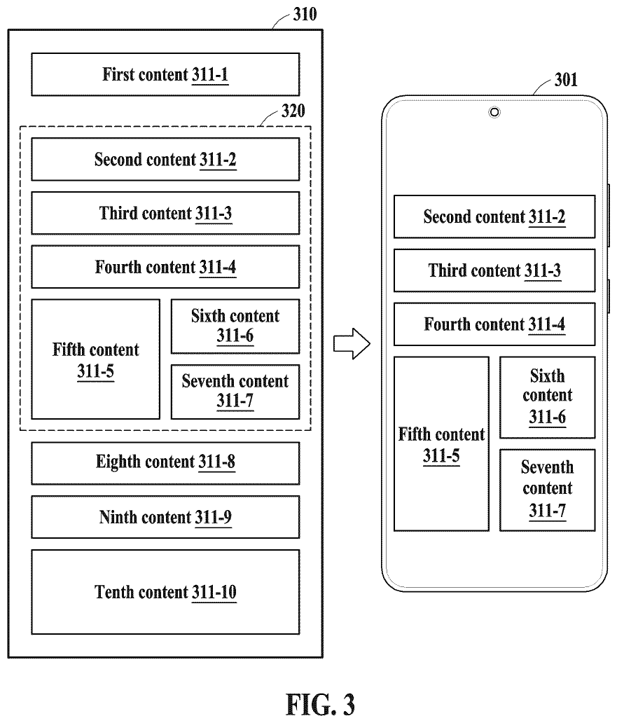

The page may include a plurality of contents. The content may include at least one of text, an image, a video, or an interfacing object. The interfacing object may be a component implemented to interact with a user, and may include, for example, a button or icon implemented to display another content and/or transition to another page in response to a user input. In the present disclosure, at least a partial area of a page displayed on the display may be referred to as a display area. Examples of the page, content, and display area are further described with reference to FIG. 3.

In operation 220a, the electronic device may determine whether to generate a sound based on information about the page.

The information about the page may include an attribute of a page determined based on metadata of the page and/or an analysis of the electronic device. The information about the page may indicate consistency of topics of the plurality of contents. Based on the information about the page, the electronic device may determine whether the topics of the contents included in the page have appropriate consistency to generate a single sound. As the topics are less consistent, the topics of the contents included in the page may be more diverse. For example, in the case of a first page and a second page providing product information in a shopping service, the first page may include product information categorized as food, and the second page may include product information categorized as beverages. The consistency of topics of the first page may be less than the consistency of topics of the second page.

According to an embodiment, the electronic device may determine whether to generate a sound based on information about the consistency of the topics of the plurality of contents of the page, wherein the information is obtained from the metadata of the page.

The metadata of the page may specify a type of the page. For example, the type of the page may be determined to be one of a portal main type, a portal sub-type, or a content type.

The page of the portal main type may provide most contents provided by a website (e.g., a portal site) corresponding to a portal service. For example, the page of the portal main type may include a main page of the portal site. The page of the portal sub-type may provide contents categorized as having topics with a common attribute (e.g., politics, economics, mail, shopping, etc.) among contents provided by the portal site. The page of the content type may refer to a page (e.g., a page on an article, a page on a product, a page on a mail, etc.) corresponding to at least one target provided by the portal site.

The metadata of the page may include information about the URL address, the HTML document, and/or the type of the page determined based on the URL address or the HTML document. For example, the electronic device may determine the type of the page to be one of the portal main type, the portal sub-type, or the content type from the metadata of the page. The electronic device may determine whether to generate a sound based on the determined type of the page. For example, the electronic device may determine to generate a sound from the plurality of contents based on the type of the page being the content type. When the type of the page is determined to be one of the portal main type or the portal sub-type, the electronic device may determine not to generate a sound from the plurality of contents.

Referring to FIG. 2B, a type of a first page 210b illustrated in FIG. 2B may be the portal main type. A type of a second page 220b may be the portal sub-type. A type of a third page 230b may be the content type. For example, the second page 220b of the portal sub-type may have a higher consistency of topic than the first page 210b of the portal main type, and the third page 230b of the content type may have a higher consistency of topic than the second page 220b of the portal sub-type.

However, the electronic device according to various embodiments of the present disclosure is not limited to determining whether to generate a sound based on the metadata of the page.

The electronic device according to an embodiment may determine whether to generate the sound from the plurality of contents based on consistency between keywords extracted from the page. For example, the electronic device may extract keywords from the plurality of contents. The electronic device may determine a consistency score of the plurality of contents using the extracted keywords. The electronic device may determine whether to generate the sound from the plurality of contents based on the determined consistency score exceeding a threshold consistency score. The electronic device may determine not to generate the sound from the plurality of contents based on the determined consistency score being less than or equal to the threshold consistency score.

According to an embodiment, the electronic device may classify the plurality of contents based on the extracted keywords. The electronic device may classify each content into a class corresponding to a keyword that is the most relevant to the content among the keywords. The electronic device may determine whether to generate the sound based on a ratio of the plurality of contents classified into the class corresponding to each keyword. When the contents are evenly classified into the classes corresponding to the keywords, the electronic device may determine not to generate the sound. When the contents are unevenly (e.g., intensively into one class) classified into the classes, the electronic device may determine to generate the sound. According to an embodiment, the electronic device may determine whether to generate the sound from the plurality of contents based on a variance in the number of contents included in each class.

For example, the electronic device may extract three keywords. Among the plurality of contents, when 80% of the contents, 10% of the contents, and 10% of the contents are classified into classes corresponding to a first keyword, a second keyword, and a third keyword, respectively, the electronic device may determine to generate the sound from the plurality of contents. Among the plurality of contents, when 35% of the contents, 35% of the contents, and 30% of the contents are classified into the classes corresponding to the first keyword, the second keyword, and the third keyword, respectively, the electronic device may determine not to generate the sound from the plurality of contents.

According to an embodiment, the electronic device may obtain a consistency score between the plurality of contents using a machine learning model. The electronic device may generate input data based on the plurality of contents and/or the keywords extracted from the plurality of contents. The electronic device may obtain output data including the consistency score by applying the machine learning model to the input data.

When the electronic device determines not to generate the sound from the plurality of contents, the electronic device according to an embodiment may not generate the sound and/or may not play the sound. When the electronic device determines not to generate the sound from the plurality of contents, the electronic device according to an embodiment may generate the sound independently of the plurality of contents and/or may play independent sound from the plurality of contents. For example, when the electronic device determines not to generate the sound from the plurality of contents, the electronic device may generate the sound independently (e.g., regardless) of the accessed page and/or the content of the accessed page. The sound that is independent of the page and/or the content of the page may also be referred to as a neutral sound.

In operation 230a, based on determining to generate the sound, the electronic device may obtain (e.g., generate) the sound using information about at least a portion of the plurality of contents.

According to an embodiment, the electronic device may obtain the sound using a sound generation model. The sound generation model may refer to a model that is generated and/or trained to output output data on the sound as the sound generation model is applied to the input data. The sound generation model according to an embodiment may be implemented based on a machine learning model (e.g., a neural network).

Referring to FIG. 2C, an electronic device 201c may generate input data using at least some of the plurality of contents included in the page. The input data of a sound generation model 203c according to various embodiments of the present disclosure may also be referred to as a prompt 202c. The sound generation model 203c may be stored in the electronic device or an external device (e.g., another electronic device, a server, or a cloud) accessible by the electronic device and may include executable program instructions. A sound 204c may be generated using the sound generation model 203c. For example, the electronic device may directly generate (e.g., on-device) the sound 204c using the sound generation model 203c. Alternatively, the electronic device may transmit the prompt 202c to the other electronic device that stores the sound generation model 203c and may receive the generated sound 204c (e.g., on-cloud).

According to an embodiment, the electronic device may generate a prompt using at least some of the plurality of contents included in the page.

For example, the input data may include text obtained from at least some of the plurality of contents. The electronic device may generate text from each content.

For example, when the content includes text, the electronic device may directly use the text included in the content to generate the input data or may use other text obtained from the text included in the content to generate the input data. For example, when the content includes text, the electronic device may extract a keyword from the text as the other text or may generate summary text that summarizes the text with the substance of the text as the other text.

For example, when the content includes an image, the electronic device may generate text that describes the image, from the image by applying image captioning. For example, when the content includes a video including a plurality of image frames, the electronic device may generate text that describes the video by applying image captioning to at least one of the plurality of image frames. According to an embodiment, image captioning may be performed using an image captioning model that is generated and/or trained to output text describing an image (or an image frame) as image captioning is applied to the image (or the image frame).

Referring to FIG. 2D, the electronic device may include a content parsing module 220d and a prompt generation module 230d, each of which may include various circuitry and/or executable program instructions. The electronic device may input contents (e.g., a video 211d, text 212d, and an image 213d) included in a page 210d to the content parsing module 220d. The content parsing module 220d may pre-process the content before inputting the content to the prompt generation module 230d. As described above, the content parsing module 220d may obtain other text (e.g., a keyword or summary text) from the text 212d. The content parsing module 220d may output text from the image 213d or the video 211d. The prompt generation module 230d may generate a prompt from the text output from the content parsing module 220d.

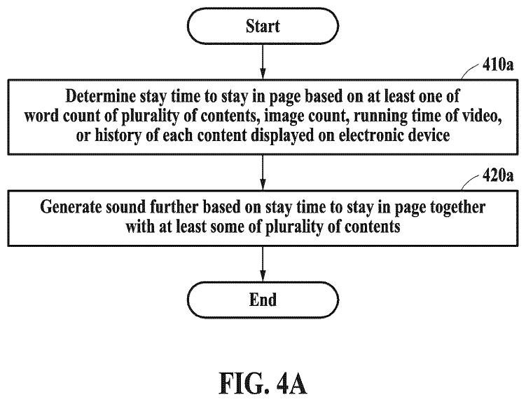

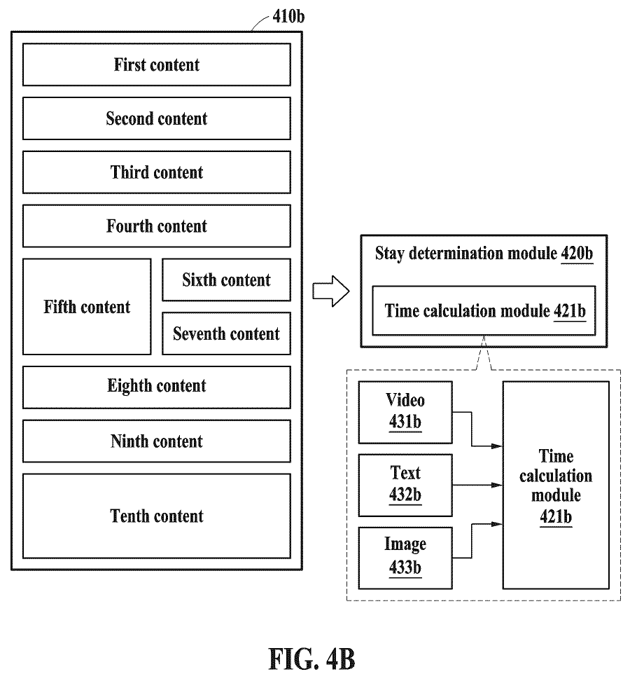

However, the electronic device according to various embodiments of the present disclosure is not limited to obtaining the sound only based on at least some of the plurality of contents. The electronic device according to an embodiment may obtain a sound based on a stay time in a page. An example of an operation of obtaining a sound based on a stay time is further described with reference to FIG. 4.

According to an embodiment, the electronic device may obtain a sound based on target content among the plurality of contents. For example, among the plurality of contents included in the page, the electronic device may determine the target content based on at least a portion (e.g., the display area) of the page displayed on the display. For example, the electronic device may determine content displayed in the display area to be the target content. For example, the electronic device may determine content disposed in an area including a point having a distance less than or equal to a threshold distance from the display area in the page to be the target content. The electronic device may obtain the sound using the target content. The electronic device may obtain the sound by applying input data generated based on the target content to the sound generation model.

The electronic device may trigger playback of the obtained sound while the page is displayed. For example, the electronic device may play the obtained sound via a speaker (e.g., the sound output module 155 of FIG. 1) while the page is displayed. The electronic device may transmit information about the obtained sound to an external device (e.g., the electronic device 102 of FIG. 1 and the electronic device 104 of FIG. 1) connected via communication (e.g., Bluetooth communication). The external device may play the sound based on receiving the information about the sound.

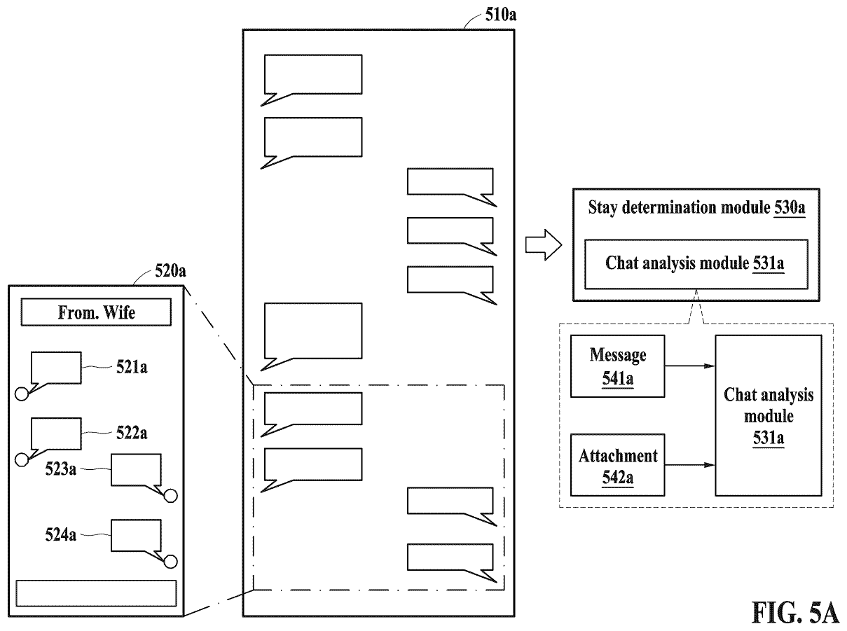

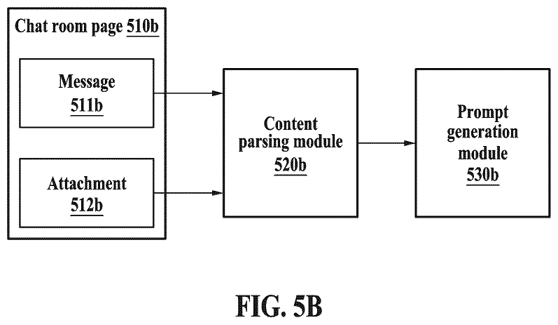

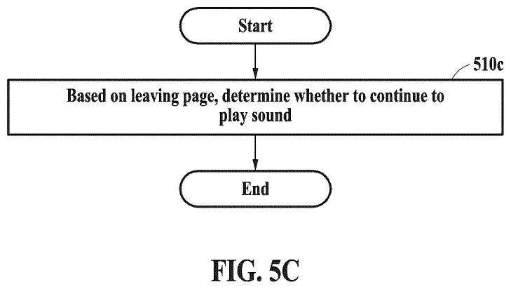

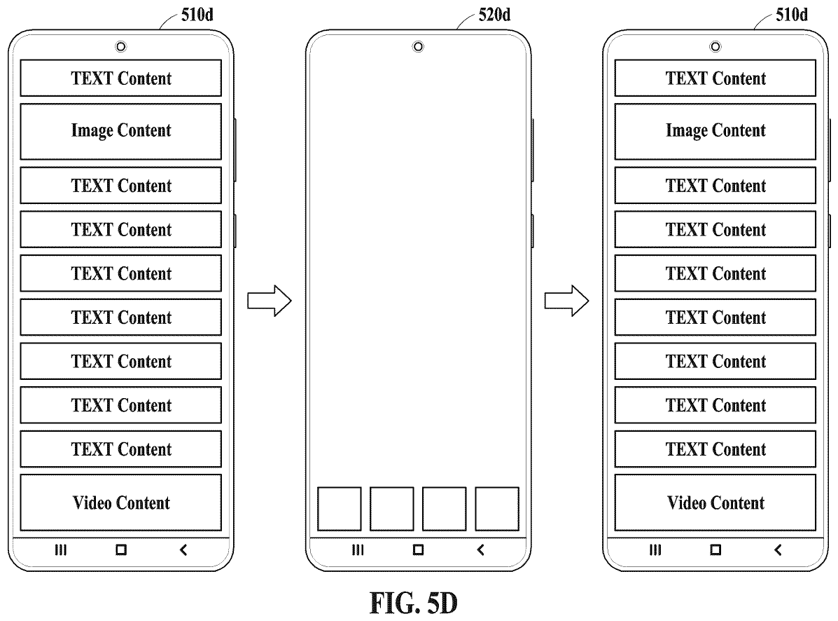

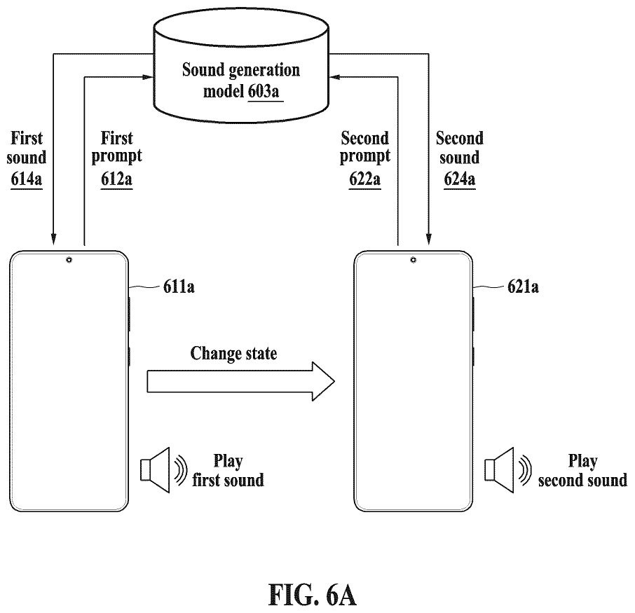

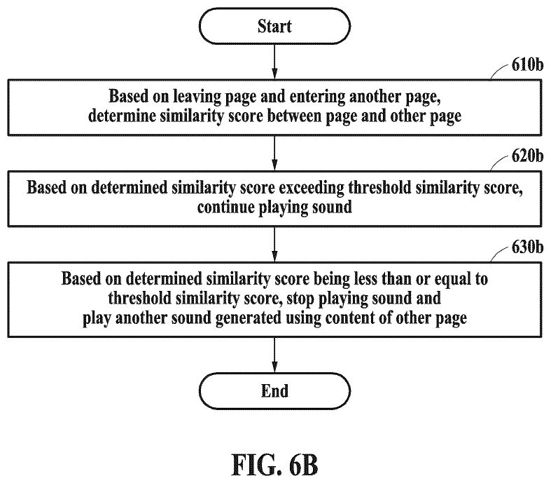

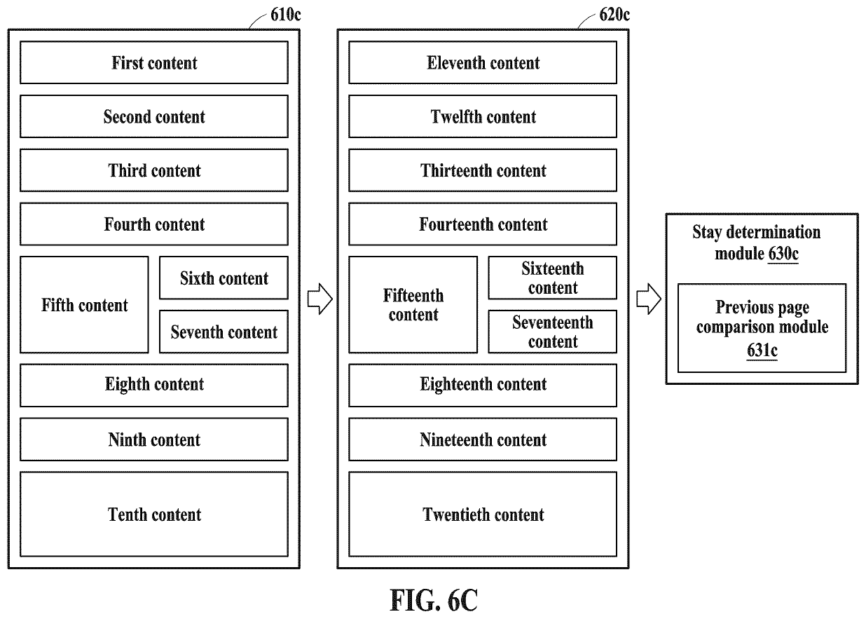

The electronic device according to an embodiment may determine whether to play the sound when leaving from the page. An example operation of the electronic device when leaving the page is described in greater detail below with reference to FIGS. 5A, 5B, 5C, 5D, 6A, and 6B.

FIG. 3 is a diagram illustrating an example of a page, a plurality of contents, and a display area according to various embodiments.

When an electronic device 301 (e.g., the electronic device 101 of FIG. 1) according to an embodiment enters a page 310, the electronic device 301 may display at least a portion of the page 310.

The page 310 according to an embodiment may include a plurality of contents. Each content included in the page 310 may be disposed on at least a partial area of the page 310. For example, in FIG. 3, the page 310 may include first content 311-1, second content 311-2, third content 311-3, fourth content 311-4, fifth content 311-5, sixth content 311-6, seventh content 311-7, eighth content 311-8, ninth content 311-9, and tenth content 311-10. Each content in the page 310 may be disposed as illustrated in FIG. 3. The first content 311-1, the third content 311-3, the fourth content 311-4, the eighth content 311-8, and the ninth content 311-9 may include text. The second content 311-2, the sixth content 311-6, and the seventh content 311-7 may include an image. The fifth content 311-5 and the tenth content 311-10 may include a video.

The electronic device 301 ma display at least a portion of the page 310 on a display (e.g., the display module 160 of FIG. 1). In various embodiments of the present disclosure, an area corresponding to at least a portion of the page 310 displayed on the display may also be referred to as a display area.

For example, in FIG. 3, the display area may include the second content 311-2, the third content 311-3, the fourth content 311-4, the fifth content 311-5, the sixth content 311-6, and the seventh content 311-7. The display area may not include the first content 311-1, the eighth content 311-8, the ninth content 311-9, and the tenth content 311-10 among the contents included in the page 310.

Although not explicitly illustrated in FIG. 3, the electronic device 301 may change the display area while maintaining the page 310 based on a user input. For example, when the electronic device 301 obtains a drag input in a first direction (e.g., from the top to bottom of the electronic device 301 illustrated in FIG. 3) while displaying the page 310, the electronic device 301 may change the display area to include the first content 311-1. For example, when the electronic device 301 obtains a drag input in a second direction (e.g., from the bottom to top of the electronic device 301 illustrated in FIG. 3) while displaying the page 310, the electronic device 301 may change the display area to include the eighth content 311-8.

FIG. 4A is a flowchart illustrating an example operation of an electronic device to obtain sound based on stay time according to various embodiments. FIG. 4B is a diagram illustrating an example operation of an electronic device to determine a stay time according to various embodiments.

An electronic device (e.g., the electronic device 101 of FIG. 1 or the electronic device 301 of FIG. 3) according to an embodiment may determine a stay time to stay in an accessed page and may obtain a sound based on the stay time. The stay time may refer to a time length of a user (or the electronic device) expected to stay in a page. According to an embodiment, the stay time may refer to a time length from a time of entering the page to a time of leaving the page. The stay time may refer to a time length taken to consume the content of the page.

According to an embodiment, the electronic device may determine the stay time based on the contents included in the page.

Referring to FIG. 4B, a page 410b may include a plurality of contents (e.g., the first to tenth contents). An electronic device according to an embodiment may include a stay determination module 420b, and the stay determination module 420b may include a time calculation module 421b, each of the modules may include various circuitry and/or executable program instructions. The stay determination module 420b may determine the stay time based on content (e.g., a video 431b, text 432b, and an image 433b) included in the page 410b. For example, the time calculation module 421b may determine the stay time based on at least one of the video 431b, the text 432b, or the image 433b.

For example, in operation 410a, the electronic device may determine the stay time based on at least one of a word count of the plurality of contents, an image count of the image 433b of the plurality of contents, a running time of the video 431b of the plurality of contents, or history of each content displayed on the electronic device.

The electronic device according to an embodiment may determine a partial stay time for each of the plurality of contents. The electronic device may determine the stay time on the page 410b by aggregating the partial stay times.

For example, as a word count of the text 432b included in each content increases, the electronic device may determine to increase the partial stay time for the corresponding content. The electronic device may determine a reading time per word (or per character) determined using information about the user. The electronic device may determine the partial stay time for the content including the text 432b based on the determined reading time per word and a word count (or the reading time per character and a character count of the text 432b) of the text 432b.

As the image count of the image 433b included in each content increases, the electronic device may determine to increase the partial stay time for the corresponding content. The electronic device may determine a stay time per image 433b using the information about the user. The electronic device may determine the partial stay time for the content including the image 433b based on the stay time per image 433b and the image count of the image 433b.

As the running time of the video 431b included in each content increases, the electronic device may determine to increase the partial stay time for the corresponding content.

For example, based on the history of each content displayed on the electronic device, the electronic device may determine the partial stay time of the corresponding content. For each content, the electronic device may determine the partial stay time of the content based on at least one of the number of times of the content displayed on the electronic device or the time length of the content displayed. For example, as the number of times of the content displayed on the electronic device increases, the electronic device may determine to decrease the partial stay time.

The electronic device according to an embodiment may determine the stay time of the page based on a previous stay time of the user. For example, the electronic device may collect at least one of information (e.g., the word count, the character count, and summary) and stay time with respect to text included in the content, information (e.g., text describing the image and color variety of the image) and stay time with respect to an image included in the content, or information (e.g., the running time of the video) and stay time with respect to a video included in the content, and may determine an expected stay time that the user may stay in the page based on the collected information.

In operation 420a, the electronic device may obtain the sound further based on the stay time on the page together with at least some of the plurality of contents.

According to an embodiment, the electronic device may determine whether to generate the sound based on the stay time. For example, when the stay time exceeds a threshold stay time, the electronic device may determine to generate the sound. When the stay time is less than or equal to the threshold stay time, the electronic device may determine not to generate and/or play the sound.

According to an embodiment, the electronic device may generate input data of the sound generation model based on the stay time. For example, the input data of the sound generation model may include information about the stay time. The sound generated based on the stay time may have a running time that is the same as or similar to the stay time. The sound generated based on the stay time may be suitable for the user to listen during the stay time.

FIG. 5A is a diagram illustrating an example operation of an electronic device to determine information regarding staying in a chat page according to various embodiments.

An electronic device (e.g., the electronic device 101 of FIG. 1, the electronic device 201c of FIG. 2C, and the electronic device 301 of FIG. 3) according to an embodiment may enter a chat room page 510a provided via a chat application. The electronic device may display at least a portion of the chat room page 510a as a display area 520a. The chat room page 510a may include a plurality of contents (e.g., a message 541a and an attachment 542a), and the display area 520a may include at least a portion (e.g., the messages 521a, 522a, 523a, 524a of a plurality of contents.

The chat room page 510a may include the plurality of contents. The electronic device according to an embodiment may include a stay determination module 530a (e.g., the stay determination module 420b of FIG. 4B), and the stay determination module 530a may include a chat analysis module 531a, each of which may include various circuitry and/or executable program instructions.

According to an embodiment, the stay determination module 530a may determine information (e.g., whether to stay, the stay time, and whether to re-enter) about stay based on some contents transmitted or received within a specific time period among the contents included in the chat room page 510a. For example, the stay determination module 530a may determine the information about stay based on the content transmitted or received within a specific time range (e.g., the last hour or the last day). For example, the chat analysis module 531a may determine the information about stay based on the message 541a or an attachment transmitted or received in the specific time range.

According to an embodiment, the chat analysis module 531a may determine whether the chat context has ended based on some contents (e.g., the contents transmitted or received in the specific time range) of the chat room page 510a. The end of the chat context may indicate whether the chat is ongoing or has ended. Based on the content of the chat room page 510a, the chat analysis module 531a may determine whether the chat context has ended based on a chat tendency (e.g., a time difference between transmission and reception times between the messages 541a) of the messages 541a transmitted or received via the chat room page 510a. The chat analysis module 531a may determine whether the chat context has ended based on information (e.g., a type of the attachment 542a and the presence of the attachment 542a) about the attachment 542a.

FIG. 5B is a diagram illustrating an example operation of an electronic device to generate a prompt for a chat page according to various embodiments.

An electronic device (e.g., the electronic device 101 of FIG. 1, the electronic device 201 of FIG. 2C, and the electronic device 301 of FIG. 3) according to an embodiment may include a content parsing module 520b (e.g., the content parsing module 220d of FIG. 2D) and a prompt generation module 530b (e.g., the prompt generation module 230d of FIG. 2D), each of which may include various circuitry and/or executable program instructions. The electronic device may input contents (e.g., a message 511b and an attachment 512b) included in a chat room page 510b to the content parsing module 520b.

For example, the electronic device may input content (e.g., a message and an attachment) transmitted or received in a specific time range among the contents included in the chat room page to the content parsing module.

For example, the electronic device may extract content from chat context, such as last content among the contents included in the chat room page. For example, a chat analysis module (e.g., the chat analysis module 531a of FIG. 5A) of the electronic device may select the content of the chat context, such as the last content among the plurality of contents by analyzing the content included in the chat room page. The various embodiments of the present disclosure describe that the electronic device inputs the content of the chat context, such as the last content of the chat room page, to the content parsing module. However, the disclosure is not limited thereto. For example, the electronic device may input the contents of the chat context, such as one or more contents included in the display area, to the content parsing module.

As described above with reference to FIG. 2C, the content parsing module may extract text from an attachment (e.g., an image and a video). The content parsing module may generate text (e.g., an output of image captioning) describing an image from the image or may extract keyword from the text describing the image. The content parsing module may generate text (e.g., an output of image captioning on at least a portion of a plurality of image frames of the video) describing a video from the video or may extract a keyword from the text describing the video. The electronic device according to an embodiment may play a sound based on the attachment in a situation where the attachment is shared (e.g., when the attachment is transmitted or received or when the attachment that is already transmitted or received is displayed) using the text extracted from the attachment to generate a prompt and/or the sound.

The content parsing module 520b may pre-process the content before inputting the content to the prompt generation module 530b. As described above, the content parsing module 520b may obtain text (e.g., a keyword and summary text) from the message 511b. The content parsing module 520b may extract text from the attachment 512b (e.g., the image and the video). The prompt generation module 530b may generate a prompt from the text output from the content parsing module 520b.

Although not explicitly illustrated in FIG. 5B, the prompt generation module 530b according to an embodiment may generate a prompt further based on the stay time together with the text output from the content parsing module 520b.

FIG. 5C is a flowchart illustrating an example operation of an electronic device to determine whether to keep playing sound when leaving a page according to various embodiments.

An electronic device (e.g., the electronic device of FIG. 1 and the electronic device 301 of FIG. 3) according to an embodiment may determine whether to continue playing a sound when leaving a page.

In operation 510c, the electronic device may determine whether to continue playing the sound based on leaving the page.

The electronic device leaving the page may indicate changing from displaying the page by the electronic device to not displaying the page. For example, the electronic device may stop displaying the page based on an access request to another page and may start displaying the other page to leave the page. For example, based on a user input to turn off at least a portion of the display, the electronic device may leave the page.

According to an embodiment, the electronic device may determine whether to re-enter the page using content displayed at the time of leaving the page. For example, the electronic device may determine whether to re-enter the page based on whether context of the content displayed at the time of leaving the page has ended. The electronic device may determine whether to continue playing the sound based on whether to re-enter the page that is determined. For example, when the electronic device determines to re-enter the page, the electronic device may determine to continue playing the sound. When the electronic device determines not to re-enter the page, the electronic device may determine to stop playing the sound.

For example, the electronic device may display a chat room page of a message application. The electronic device may determine whether chat context of the contents (e.g., messages) included in the chat room page has ended. When the chat context does not end (e.g., the chat context is ongoing), the possibility of a new message displayed on the chat room page may be a first possibility. When the chat context has ended, the possibility of a new message displayed on the chat room page may be a second possibility that is lower than the first possibility. When the electronic device determines that the chat context shown in the message at the time of leaving the page has ended, the electronic device may determine not to re-enter the page. When the electronic device determines that chat context shown in the message at the time of leaving the page is determined is not ended, the electronic device may determine to re-enter the page.

FIG. 5D is a diagram illustrating an example operation of an electronic device to play sound when re-entering a page within a threshold time according to various embodiments.

An electronic device (e.g., the electronic device 101 of FIG. 1, the electronic device 201c of FIG. 2C, and the electronic device 301 of FIG. 3) according to an embodiment may monitor re-entry to a page within a threshold time and may determine whether to continue playing sound based on re-entry to the page. The electronic device determine to continue playing the sound based on re-entering the page within the threshold time from the time of leaving the page. The electronic device may determine to stop playing the sound based on that the electronic device does not re-enter the page within the threshold time from the time of leaving the page.

For example, the electronic device may continue playing the sound within the threshold time based on leaving the page. When the electronic device re-enters the page within the threshold time, the electronic device may play the sound after the threshold time. When the electronic device does not re-enter the page within the threshold time, the electronic device may stop playing the sound after the threshold time has elapsed.

Referring to FIG. 5D, the electronic device may enter a first page 510d. The first page 510d may be a page (e.g., a page of the content type) provided via an application installed in the electronic device. The electronic device may leave the first page 510d and may enter a second page 520d. The second page 520d may be a page (e.g., a home screen of a user interface (UI) provided independently of an application installed in the electronic device based on a user input. The electronic device may re-enter the first page 510d within the threshold time from the time of leaving the first page 510d. Even when the electronic device leaves the first page 510d, the electronic device may continue playing the sound when the electronic device re-enters the first page 510d within the threshold time.

FIG. 6A is a diagram illustrating an example electronic device to generate different sounds when moving from a page to another page according to various embodiments.

According to an embodiment, an electronic device (e.g., the electronic device 101 of FIG. 1, the electronic device 201c of FIG. 2C, and the electronic device 301 of FIG. 3) may change a displayed page from a first page to a second page.

A state of the electronic device may be a first state. The first state may refer to a state in which the electronic device enters the first page (e.g., enters the first page and does not leave the first page). An electronic device 611a in the first state may input a first prompt 612a to a sound generation model 603a and may obtain a first sound 614a.

The state of the electronic device may be changed from the first state to a second state. The second state may refer to a state in which the electronic device enters a second page that is different from the first page. A change in the state of an electronic device from a first state to a second state may be interpreted as substantially equivalent to the electronic device leaving the first page and entering the second page.

An electronic device 621a in the second state may input a second prompt 622a to the sound generation model 603a and may obtain a second sound 624a. The electronic device in the second state may play the second sound 624a.

FIG. 6B is a flowchart illustrating an example operation of an electronic device to determine whether to keep playing sound based on a similarity between a page and another page when moving from the page to the other page according to various embodiments. FIG. 6C is a diagram illustrating an example electronic device to determine a similarity between pages using a previous page comparison module of a stay determination module according to various embodiments.

An electronic device (e.g., the electronic device 101 of FIG. 1 and the electronic device 301 of FIG. 3) according to an embodiment may determine whether to continue playing a sound when moving from a page to another page. Moving from a page to another page by the electronic device may indicate that the electronic device leaves the page and enters the other page.

In operation 610b, based on leaving the page and entering another page, the electronic device may determine a similarity score between the page and the other page.

According to an embodiment, the electronic device may determine the similarity score between the page and the other page based on a result of comparing first input data of a sound generation model based on the page to second input data of the sound generation model based on the other page. The electronic device may generate the first input data of the sound generation model based on at least a portion of the page. Based on moving from the page to the other page, the electronic device may generate the second input data of the sound generation model based on at least a portion of the other page. For example, the electronic device may obtain a first embedding vector by applying an embedding vector generation model to the first input data and may obtain a second embedding vector by applying the embedding vector generation model to the second input data. The electronic device may determine similarity (e.g., cosine similarity) between the first embedding vector and the second embedding vector to be the similarity score between the page and the other page.

However, in various embodiments of the present disclosure, the electronic device is not limited to determining the similarity score between pages using the input data of the sound generation model. The electronic device according to an embodiment may determine the similarity score between the page and the other page based on a result of comparing contents included in the page and the other page.

Referring to FIG. 6C, the electronic device may leave a first page 610c and may enter the second page 620c. For example, the first page 610c may include first content to tenth content, and the second page 620c may include eleventh content to twentieth content. The electronic device according to an embodiment may include a stay determination module 630c (e.g., the stay determination module 420b of FIG. 4B and the stay determination module 530a of FIG. 5A), and the stay determination module 630c may include a previous page comparison module 631c. For example, the previous page comparison module 631c may determine a similarity score between the first page 610c and the second page 620c based on first input data generated from the first page 610c and second input data generated from the second page 620c. The previous page comparison module 631c may determine the similarity score between the first page 610c and the second page 620c based on a result of comparing contents of the first page 610c with contents of the second page 620c.

In operation 620b, the electronic device may determine to continue playing a sound based on the determined similarity score exceeding a threshold similarity score.

In operation 630b, based on the determined similarity score being less than or equal to the threshold similarity score, the electronic device may determine to stop playing the sound and play another sound obtained using content of another page.

The electronic device according to an embodiment may generate and play the other sound based on at least some of a plurality of contents of the other page. The electronic device may obtain the other sound in the same or similar manner as described above with reference to FIGS. 2 to 5.

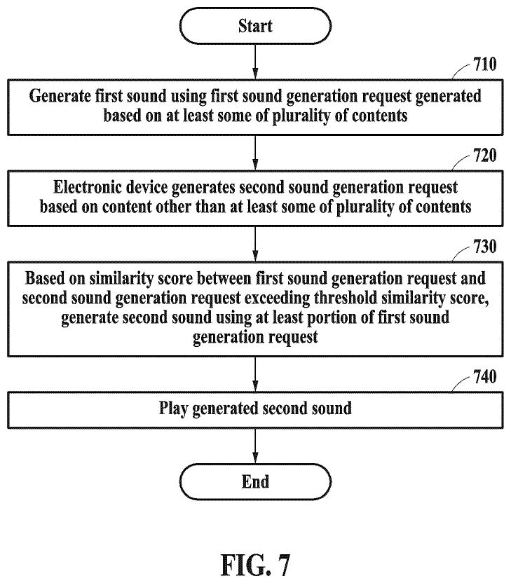

FIG. 7 is a flowchart illustrating an example operation of an electronic device to obtain a plurality of sounds according to various embodiments.

When obtaining a plurality of sounds, an electronic device (e.g., the electronic device 101 of FIG. 1 and the electronic device 301 of FIG. 3) according to an embodiment may use a first sound generation request that is used for obtaining a first sound, to obtain a second sound.

In operation 710, the electronic device may obtain (or generate) the first sound using the first sound generation request generated based on at least some of a plurality of contents. In various embodiments of the present disclosure, the sound generation request may also be referred to as a seed for obtaining a sound.

According to an embodiment, the electronic device may obtain the first sound using the sound generation model. The first sound generation request may include first input data of the sound generation model. The electronic device may obtain the first sound by applying the sound generation model to the first input data.

According to an embodiment, the electronic device may store the first sound and the first sound generation request. The electronic device may store a pair including the first sound generation request and the first sound.

In operation 720, the electronic device may generate a second sound generation request based on another content that is different from the at least some of the plurality of contents. The second sound generation request be generated based on the other content that is different from the at least some of the plurality of contents used for the first sound generation request.

For example, based on leaving the page and entering the other page, the electronic device may generate the second sound generation request based on the content of the other page.

In another example, based on the display area changing from a first area of the page to a second area of the page, the electronic device may generate the second sound generation request based on content determined based on the second area. The first sound generation request and the second sound generation request may be generated using the content included in the same page. The content used for the first sound generation request and the content used for the second sound generation request may be at least partially different from each other.

According to an embodiment, when the electronic device obtains the sound using the sound generation model, the second sound generation request may include second input data of the sound generation model.

In operation 730, based on a similarity score between the first sound generation request and the second sound generation request exceeding a threshold similarity score, the electronic device may obtain the second sound using at least a portion of the first sound generation request.

The electronic device may calculate the similarity score between the first sound generation request and the second sound generation request using a machine learning model. For example, the electronic device may use an embedding vector output model that outputs an embedding vector corresponding to a sound generation request as the embedding vector output model is applied to the sound generation request. The electronic device may output a first embedding vector by applying the embedding vector output model to the first sound generation request. The electronic device may output a second embedding vector by applying the embedding vector output model to the second sound generation request. The electronic device may calculate the similarity score between the first sound generation request and the second sound generation request based on similarity (e.g., cosine similarity) between the first embedding vector and the second embedding vector.

The electronic device may generate the second sound generation request that is similar to the first sound generation request by changing at least a portion of the first sound generation request based on the other content. The electronic device may generate the second sound using the second sound generation request. The second sound may be the same as or similar to the first sound.

In operation 740, the electronic device may play the generated second sound.

In various embodiments of the present disclosure, the electronic device is not limited to generating the second sound that is different from the first sound.

According to an embodiment, when the similarity score between the first sound generation request and the second sound generation request is greater than a first threshold similarity score and less than or equal to a second threshold similarity score, the electronic device may generate the second sound generation request that is different from the first sound generation request and may generate the second sound that is different from the first sound based on the second sound generation request. When the similarity score between the first sound generation request and the second sound generation request is greater than the second threshold similarity score, the electronic device may play the first sound. When the similarity score between the first sound generation request and the second sound generation request is greater than the second threshold similarity score, the electronic device may skip generation of the second sound generation request and generation of the second sound.

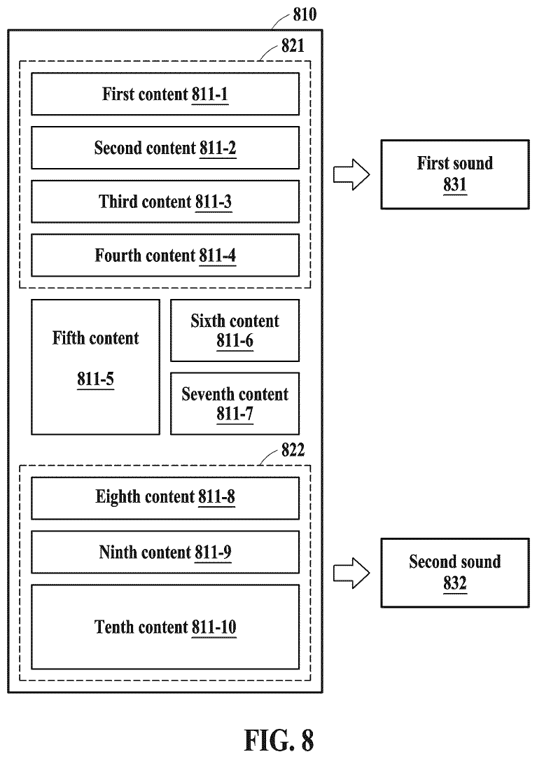

FIG. 8 is a diagram illustrating an example operation of an electronic device to play sound when entering a page containing a plurality of contents classified into a plurality of topics according to various embodiments.

When entering a page 810 including a plurality of contents classified into a plurality of topics, an electronic device (e.g., the electronic device 101 of FIG. 1 and the electronic device 301 of FIG. 3) according to an embodiment may play a sound respectively corresponding to each topic.

The electronic device may classify the plurality of contents into the plurality of topics. For example, the electronic device may obtain output data corresponding to the plurality of topics by applying a machine learning model (e.g., a topic extraction model) to input data generated based on the plurality of contents. The topic may represent a substance and/or atmosphere of the content. For example, the topic may be extracted in the form of a keyword.

The electronic device may obtain a sound corresponding to each topic using the content classified into the topic. For example, based on the content classified into each topic, the electronic device may obtain a sound generation request for the topic. Based on the sound generation request for the topic, the electronic device may obtain a sound corresponding to the topic. The electronic device may play the sound corresponding to the topic of the content displayed on a display.

According to an embodiment, based on the topic of the content displayed in the page 810 changing from a first topic to a second topic, the electronic device may change the sound played via a speaker to a first sound 831 corresponding to the first topic to a second sound 832 corresponding to the second topic.

According to an embodiment, the electronic device may generate an intermediate sound for transitioning between the first sound 831 and the second sound 832 in the arrangement of the contents in the page 810. The intermediate sound may refer to a sound that smoothly connects the first sound 831 to the second sound 832 when the first sound 831 is transitioned (e.g., changed) to the second sound 832.

For example, when the contents of the first topic are disposed adjacent to the contents of the second topic in the page 810, the electronic device may generate the intermediate sound for transitioning between the first sound 831 and the second sound 832. Based on the topic of the content displayed in the page 810 changing from the first topic to the second topic, the electronic device may change the sound played via the speaker from the first sound 831 to the second sound 832 through the intermediate sound. For example, when all the contents displayed in the page 810 are classified into the first topic, the electronic device may play the first sound 831. When some of the contents displayed in the page 810 are classified into the first topic and the other contents are classified into the second topic, the electronic device may play the intermediate sound. When all the contents displayed in the page 810 are classified into the second topic, the electronic device may play the second sound 832.

In another example, when the contents of the first topic are not disposed adjacent to the contents of the second topic in the page 810, the electronic device may not generate the intermediate sound for transitioning between the first sound 831 and the second sound 832. When the contents of the first topic are not disposed adjacent to the contents of the second topic in the page 810, since there is little to no possibility that the topic of the contents displayed in the page 810 is changed directly from the first topic to the second topic, the intermediate sound for transitioning between the first sound 831 and the second sound 832 may not be generated.

In FIG. 8, the electronic device may enter the page 810. The page 810 may include a plurality of contents. Each content included in the page 810 may be disposed on at least a partial area of the page 810. For example, in FIG. 8, the page 810 may include first content 811-1, second content 811-2, third content 811-3, fourth content 811-4, fifth content 811-5, sixth content 811-6, seventh content 811-7, eighth content 811-8, ninth content 811-9, and tenth content 811-10. In the page 810, each content may be disposed as illustrated in FIG. 8.

The plurality of contents of the page 810 may be classified into one of two topics. For example, the first content 811-1, the second content 811-2, the third content 811-3, the fourth content 811-4, the fifth content 811-5, the sixth content 811-6, and the seventh content 811-7 may be classified into the first topic. The eighth content 8811-8, the ninth content 811-9, and the tenth content 811-10 may be classified into the second topic.

The electronic device may display a first area 821 of the page 810 on a display. For example, the display area may be the first area 821. While the electronic device displays the first area 821, the electronic device may play the first sound 831 based on content included in the first area 821. While the electronic device displays a second area 822, the electronic device may play the second sound 832 based on content included in the second area 822.

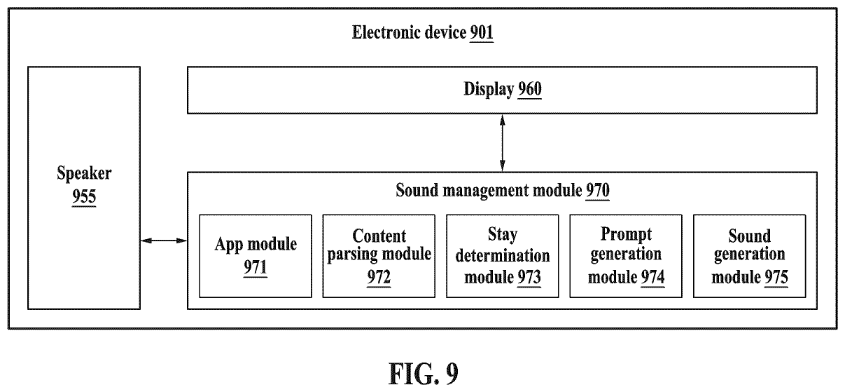

FIG. 9 is a block diagram illustrating an example configuration of an electronic device according to various embodiments.

An electronic device 901 (e.g., the electronic device 101 of FIG. 1 and the electronic device 401 of FIG. 4) according to an embodiment may include a display 950 (e.g., the display module 160 of FIG. 1), a speaker 955 (e.g., the sound output module 155 of FIG. 1), and the sound generation module 970 (e.g., including various modules, each of which may include various circuitry and/or executable program instructions).

When the electronic device 901 enters a page (e.g., the page 310 of FIG. 3 and the page 810 of FIG. 8), the electronic device 901 may display at least a portion of the page on a display 950.

According to an embodiment, the sound generation module 970 may include an app module 971, a content parsing module 972 (e.g., the content parsing module 220d of FIG. 2D and the content parsing module 520b of FIG. 5B), a stay determination module 973 (e.g., the stay determination module 420b of FIG. 4B, the stay determination module 530a of FIG. 5A, and the stay determination module 630c of FIG. 6C), a prompt generation module 974 (e.g., the prompt generation module 230d of FIG. 2D and the prompt generation module 530b of FIG. 5B), and a sound generation module 975.

The app module 971 according to an embodiment may transmit information for displaying a page to the display 960. The app module 971 may transmit information about a plurality of contents included in the page to the content parsing module 972 and/or the stay determination module 973.

The content parsing module 972 according to an embodiment may receive the information about the plurality of contents included in the page from the app module 971. The content parsing module 972 may parse at least some of the plurality of contents. Parsing the content may refer to extracting a component of the content by analyzing the content. For example, the content parsing module 972 may extract a keyword from content including text. For example, the content parsing module 972 may extract, from content including an image, a caption of the image describing the image and/or a keyword based on the image. For example, the content parsing module 972 may extract, from content including a video, a caption of the video (or an image frame included in the video) describing the video and/or a keyword based on the video. The content parsing module 972 may transmit the component of the content obtained by parsing the content to the stay determination module 973 and/or the prompt generation module 974.

The stay determination module 973 may receive the component of the content from the content parsing module 972 and/or may receive the information about the plurality of contents from the app module 971. Based on the component of the content or the plurality of contents, the stay determination module 973 may determine information regarding whether the electronic device 901 stays in the page. For example, based on the component of the content or the plurality of contents, the stay determination module 973 may determine a stay time. Based on history of each content displayed on the electronic device 901, the stay determination module 973 may determine the stay time. The stay determination module 973 may transmit the determined stay time to the prompt generation module 974. For example, the stay determination module 973 may determine whether to stay based on chat context between a plurality of contents included in a chat page.

The prompt generation module 974 according to an embodiment may receive information about the plurality of contents from the app module 971 and/or may receive the component of the content from the content parsing module 972. The prompt generation module 974 may receive the determined stay time and/or whether to stay from the stay determination module 973. The prompt generation module 974 may generate a prompt (e.g., input data of the sound generation module and the sound generation request) to generate a sound based on the content (or the component of the content) and/or the stay time. The prompt generation module 974 may transmit the generated prompt to the sound generation module 975.

The sound generation module 975 according to an embodiment may receive the prompt from the prompt generation module 974. The sound generation module 975 may generate a sound based on the prompt. The sound generation module 975 may transmit information about the generated sound to the speaker 955.

The speaker 955 according to an embodiment may receive the information about the sound from the sound management module 970 and/or the sound generation module 975. The speaker 955 may play the generated sound.

In FIG. 9, the sound generation module 975 is illustrated as a component of the electronic device 901 but the disclosure is not limited thereto. For example, the sound generation module 975 may be a component of an external electronic device other than the electronic device 901. The prompt generation module 974 may transmit the prompt to the sound generation module 975 of another electronic device via a communication module (e.g., the communication module 190 of FIG. 1) of the electronic device 901. When receiving the prompt, the sound generation module 975 of the other electronic device may generate a sound based on the prompt. The other electronic device may transmit the generated sound to the electronic device 901. The electronic device 901 may obtain the sound generated by the other electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “first,” “second,” “first,” or “second” may be used simply to distinguish one component from another and may not limit the components with respect to other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The various example embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors. Thus, the processing device may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a speaker;
a display;
at least one processor, comprising processing circuitry; and
a memory storing instructions,
wherein at least one processor, individually and/or collectively, is configured to execute the instructions and to cause the electronic device to:
based on entering a page including a plurality of contents, display at least a portion of the page on the display,
based on information about the page, determine whether to generate a sound, and
based on determining to generate the sound, obtain the sound using information about at least some of the plurality of contents.

2. The electronic device of claim 1,
wherein at least one processor, individually and/or collectively, is configured to cause the electronic device to:
determine whether to generate the sound based on information about consistency of topics of the plurality of contents of the page, wherein the information is obtained from metadata of the page.

3. The electronic device of claim 1,
wherein at least one processor, individually and/or collectively, is configured to cause the electronic device to:
extract keywords from the plurality of contents,
determine a consistency score of the plurality of contents using the extracted keywords,
based on the determined consistency score exceeding a threshold consistency score, determine to generate the sound from the plurality of contents, and
based on the determined consistency score being less than or equal to the threshold consistency score, determine not to generate the sound from the plurality of contents.

4. The electronic device of claim 1,
wherein at least one processor, individually and/or collectively, is configured to cause the electronic device to:
determine a stay time to stay in the page based on at least one of a word count of the plurality of contents, an image count of the plurality of contents, a running time of video of the plurality of contents, and/or history of each content displayed on the electronic device.

5. The electronic device of claim 1,
wherein at least one processor, individually and/or collectively, is configured to cause the electronic device to:
obtain the sound further based on the stay time to stay in the page together with the at least some of the plurality of contents.

6. The electronic device of claim 1,
wherein at least one processor, individually and/or collectively, is configured to cause the electronic device to:
based on leaving the page, determine whether to re-enter the page using content displayed at a time of leaving the page, and
determine whether to continue playing the sound based on the determination of whether to re-enter the page.

7. The electronic device of claim 1,
wherein at least one processor, individually and/or collectively, is configured to cause the electronic device to:
based on re-entering the page within a threshold time from the time of leaving the page, determine to continue playing the sound, and
based on not re-entering the page within the threshold time from the time of leaving the page, determine to stop playing the sound.

8. The electronic device of claim 1,
wherein at least one processor, individually and/or collectively, is configured to cause the electronic device to:
based on leaving the page and entering another page, determine a similarity score between the page and the other page,
based on the determined similarity score exceeding a threshold similarity score, determine to continue playing the sound, and
based on the determined similarity score being less than or equal to the threshold similarity score, determine to stop playing the sound and play another sound obtained using content of the other page.

9. The electronic device of claim 1,
wherein at least one processor, individually and/or collectively, is configured to cause the electronic device to:
obtain a first sound using a first sound generation request generated based on the at least some of the plurality of contents,
generate a second sound generation request based on content other than the at least some of the plurality of contents, and
based on a similarity score between the first sound generation request and the second sound generation request exceeding a threshold similarity score, obtain a second sound using at least a portion of the first sound generation request, and
play the second sound.

10. The electronic device of claim 1,
wherein at least one processor, individually and/or collectively, is configured to cause the electronic device to:
classify the plurality of contents into a plurality of topics,
obtain a sound corresponding to each of the topics using content classified into each of the topics,
play the sound corresponding to a topic of content displayed on the display, and
based on content displayed in the page changing from a first topic to a second topic, change a sound played via the speaker from the first sound corresponding to the first topic to the second sound corresponding to the second topic.

11. The electronic device of claim 1,
wherein at least one processor, individually and/or collectively, is configured to cause the electronic device to:
among the plurality of contents, determine target content based on the at least a portion of the page displayed on the display, and
obtain the sound using the target content.

12. A method performed by an electronic device, the method comprising:
based on entering a page including a plurality of contents, displaying at least a portion of the page on a display;
based on information about the page, determining whether to generate a sound; and
based on the determination to generate the sound, obtaining the sound using information about at least some of the plurality of contents.

13. The method of claim 12,
wherein the determining of whether to generate the sound comprises:
determining whether to generate the sound based on information about consistency of topics of the plurality of contents of the page, wherein the information is obtained from metadata of the page.

14. The method of claim 12,
wherein the determining of whether to generate the sound comprises:
extracting keywords from the plurality of contents;
determining a consistency score of the plurality of contents using the extracted keywords;
based on the determined consistency score exceeding a threshold consistency score, determining to generate the sound from the plurality of contents; and
based on the determined consistency score being less than or equal to the threshold consistency score, determining not to generate the sound from the plurality of contents.

15. The method of claim 12,
wherein the obtaining of the sound comprises:
determining a stay time to stay in the page based on at least one of a word count of the plurality of contents, an image count of the plurality of contents, a running time of video of the plurality of contents, and/or history of each content displayed on the electronic device.

16. The method of claim 12,
wherein the obtaining of the sound comprises:
obtaining the sound further based on the stay time to stay in the page together with the at least some of the plurality of contents.

17. The method of claim 12, further comprising:
based on leaving the page, determining whether to re-enter the page using content displayed at a time of leaving the page, and
determining whether to continue playing the sound based on the determination of whether to re-enter the page.

18. The method of claim 12, further comprising:
based on re-entering the page within a threshold time from the time of leaving the page, determining to continue playing the sound, and
based on not re-entering the page within the threshold time from the time of leaving the page, determining to stop playing the sound.

19. The method of claim 12, further comprising:
based on leaving the page and entering another page, determining a similarity score between the page and the other page,
based on the determined similarity score exceeding a threshold similarity score, determining to continue playing the sound, and
based on the determined similarity score being less than or equal to the threshold similarity score, determining to stop playing the sound and play another sound obtained using content of the other page.

20. A non-transitory computer-readable storage medium storing instructions that, when executed by at least one processor, comprising processing circuitry, individually and/or collectively, cause an electronic device to perform the method of claim 12.
